(19) United States
(12) Patent Application Publication
(10) Pub. No.: US 2019/0375332 A1
(43) Pub. Date: Dec. 12, 2019

(54) AUTOMATIC MIRROR AND ADJUSTMENT

(71) Applicant: Panasonic Automotive Systems Company of America, Division of Panasonic Corporation of North America, Peachtree city, GA (US)

(72) Inventors: EDO OMANOVIC, LIVONIA, MI (US); PATRICK O'CONNELL, NOVI, MI (US)

(73) Assignee: Panasonic Automotive Systems Company of America, Division of Panasonic Corporation of North America

(21) Appl. No.: 16/430,488

(22) Filed: Jun. 4, 2019

Related U.S. Application Data
(60) Provisional application No. 62/681,253, filed on Jun. 6, 2018.

(51) Int. Cl. B60R 1/072; B60R 1/04

(52) U.S. Cl. CPC B60R 1/072; B60R 1/04

(57) ABSTRACT

An automatic mirror adjustment arrangement for a motor vehicle includes a sensor detecting a height of eyes of a driver of the motor vehicle. An electronic processor is communicatively coupled to the sensor and determines a desired orientation of a mirror within the motor vehicle based upon the detected height of the eyes of the driver. The processor transmits a control signal dependent upon the determined desired orientation of the mirror. An actuator is communicatively coupled to the electronic processor and receives the control signal. The actuator moves the mirror into the determined desired orientation based upon the control signal.

### CROSS-REFERENCE TO RELATED APPLICATIONS

This application claims benefit of U.S. Provisional Application No. 62/681,253 filed on Jun. 6, 2018, which the disclosure of which is hereby incorporated by reference in its entirety for all purposes.

### FIELD OF THE INVENTION

The disclosure relates to automatic mirror adjustment in a motor vehicle.

### BACKGROUND OF THE INVENTION

Once a driver enters a vehicle, they don't always check to make sure their mirrors are in the correct locations. When the need to merge on a highway comes up and they try to use the mirrors, the mirrors may not be in the correct position, which may make it dangerous to merge.

Currently, there is no automatic mirror adjustment available on the market. In all vehicles, the driver has to manually set the mirror positions using switches in the vehicle.

### SUMMARY

The present invention may utilize a driver monitoring system (DMS) to determine exactly where the driver's eyes are located. Based on this eye location information, the orientations of the side view mirrors and rearview mirror may be automatically adjusted so that the driver does not have to manually do this himself. The invention may eliminate the manual portion of the process and automatically adjusts the mirrors for the driver as soon as he turns on the vehicle.

In one embodiment, the invention comprises an automatic mirror adjustment arrangement for a motor vehicle, including a sensor detecting a height of eyes of a driver of the motor vehicle. An electronic processor is communicatively coupled to the sensor and determines a desired orientation of a mirror within the motor vehicle based upon the detected height of the eyes of the driver. The processor transmits a control signal dependent upon the determined desired orientation of the mirror. An actuator is communicatively coupled to the electronic processor and receives the control signal. The actuator moves the mirror into the determined desired orientation based upon the control signal.

In another embodiment, the invention comprises an automatic mirror adjustment method for a motor vehicle, including detecting a height of eyes of a driver of the motor vehicle. A desired orientation of a mirror within the motor vehicle is determined based upon the detected height of the eyes of the driver. A control signal is transmitted dependent upon the determined desired orientation of the mirror. The mirror is moved into the determined desired orientation based upon the control signal.

In yet another embodiment, the invention comprises an automatic mirror adjustment arrangement for a motor vehicle, including a sensor detecting a three-dimensional location of eyes of a driver of the motor vehicle. An electronic processor is communicatively coupled to the sensor and determines a desired orientation of a mirror within the motor vehicle based upon the detected three-dimensional location of the eyes of the driver. A control signal is transmitted dependent upon the determined desired orientation of the mirror. An actuator is communicatively coupled to the electronic processor and receives the control signal. The actuator moves the mirror into the determined desired orientation based upon the control signal.

An advantage of the present invention is that it places the mirrors in proper orientations without the driver having to take the time to do so manually.

### BRIEF DESCRIPTION OF THE DRAWINGS

A better understanding of the present invention will be had upon reference to the following description in conjunction with the accompanying drawings.

FIG. 1 is a block diagram of one embodiment of an automotive automatic mirror adjustment arrangement of the present invention.

FIG. 2 is a side sectional view of an automobile including the driver monitoring system of the automotive automatic mirror adjustment arrangement of FIG. 1.

FIG. 3 is a rear sectional view of the automobile of FIG. 2.

FIG. 4 is a flow chart of one embodiment of an automatic mirror adjustment method of the present invention for a motor vehicle.

### DETAILED DESCRIPTION OF THE PREFERRED EMBODIMENTS

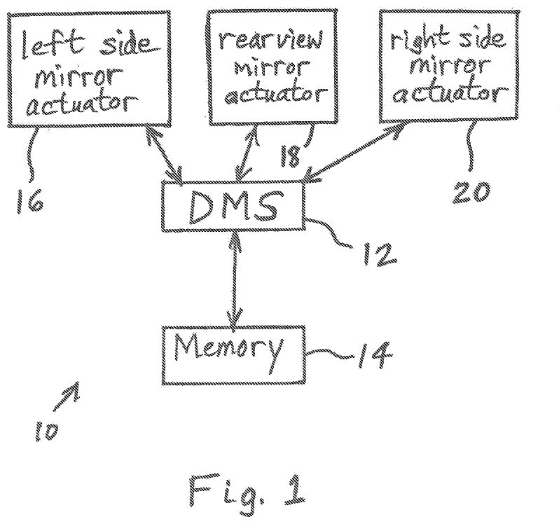

FIG. 1 illustrates one embodiment of an automotive automatic mirror adjustment arrangement 10 of the present invention, including a driver monitoring system (DMS) 12, a memory device 14, a left-side mirror actuator 16, a rearview mirror actuator 18, and a right-side mirror actuator 20. DMS 12 may include a camera (not shown) or other sensor that detects positions of the driver's eyes in three-dimensional space. The determination of the positions of the driver's eyes may be performed in conjunction with an electronic processor (not shown) within DMS 12. It is also possible for the electronic processor to be disposed outside of DMS 12.

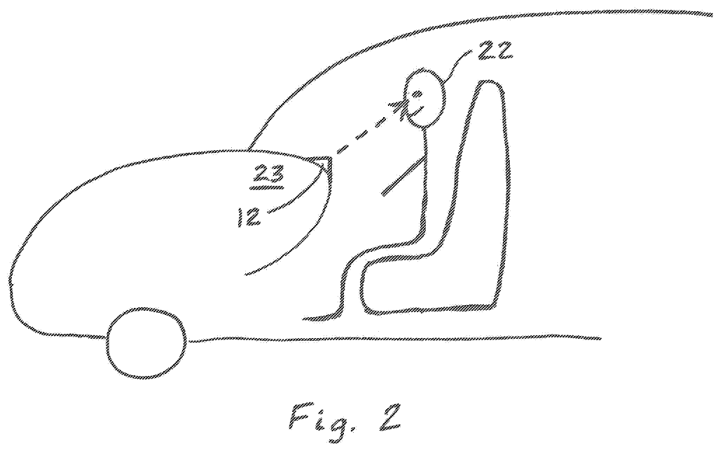

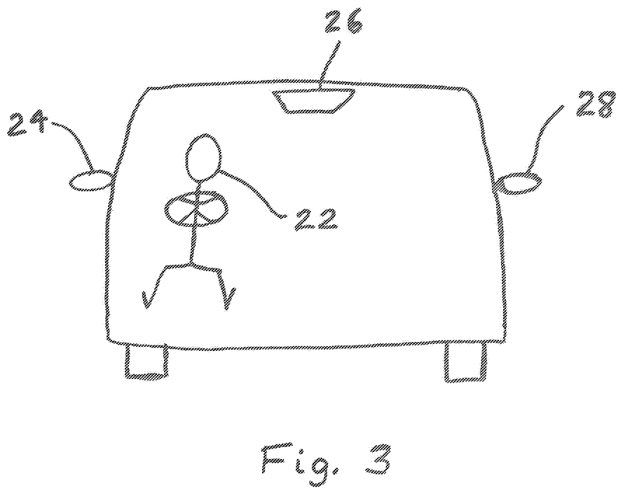

FIG. 2 illustrates one embodiment of an automobile including DMS 12 of automotive automatic mirror adjustment arrangement 10 of FIG. 1. DMS 12 includes a camera or other sensor that can detect the locations of the eyes of a driver 22. DMS 12 may detect the height of the driver's eyes. DMS 12 may detect the height of the eyes of the driver relative to a vertical position of the sensor. The electronic processor within DMS 12 may take this height value and calculate therefrom a desired orientation of each of a left side (i.e., driver's side) view mirror 24 (FIG. 3), a rearview mirror 26, and a right side (i.e. passenger's side) mirror 28. The desired orientations may be retrieved from a lookup table within memory 14 where the orientations may be stored in association with eye positions. Based on the desired orientations of the mirrors, and the current orientations of the mirrors, the processor may calculate how far and in which directions to move the side and rearview mirrors in order to arrive at the desired orientations.

DMS 12 may be supported by a dashboard 23 of the motor vehicle.

FIG. 3 illustrates driver 22 and all of the mirrors from the rear of the car. The mirrors include a driver side mirror 24, a rearview mirror 26, and a passenger side mirror 28. Both of the side view mirrors 24, 28 along with the rearview mirror 26 may be automatically adjusted for driver 22 once he enters the car and turns on the vehicle. This adjustment may happen after every ignition cycle.

During use, upon driver 22 sitting down in the driver's seat, or, in one embodiment, turning on the engine ignition, DMS 12 uses its driver-monitoring camera or other sensor to detect the three-dimensional position of the driver's eyes. Based on the detected eye position, DMS 12 may look up in memory 14 the desired positions or orientations of mirrors 24, 26 and 28. Such desired positions or orientations may provide driver 22 with the best, clearest, and/or most unobstructed view of relevant spaces next to and/or behind the car. After retrieving the desired positions or orientations of mirrors 24, 26 and 28 from memory, DMS 12 may control actuators 16, 18 and 20 to achieve the desired positions or orientations.

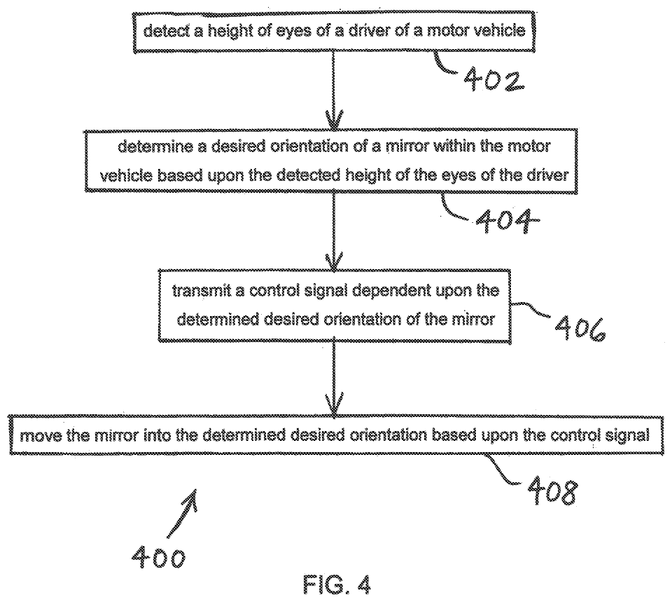

FIG. 4 illustrates one embodiment of an automatic mirror adjustment method 400 of the present invention for a motor vehicle. In a first step 402, a height of the eyes of a driver of the motor vehicle is detected. For example, DMS 12 includes a camera or other sensor that can detect the locations of the eyes of a driver 22, and, from these locations, DMS 12 may determine the height of the eyes of the driver relative to a vertical position of the sensor.

Next, in step 404, a desired orientation of a mirror within the motor vehicle is determined based upon the detected height of the eyes of the driver. For example, an electronic processor within DMS 12 may take the determined eye height value and calculate therefrom a desired orientation of each of a left-side (i.e., driver's side) view mirror 24 (FIG. 3), a rearview mirror 26, and a right-side (i.e., passenger's side) mirror 28. The desired orientations may be retrieved from a lookup table within memory 14 where the orientations may be stored in association with eye heights.

In a next step 406, a control signal is transmitted dependent upon the determined desired orientation of the mirror. For example, DMS 12 may transmit control signals to actuators 16, 18 and 20 to achieve the desired positions or orientations of the mirror.

In a final step 408, the mirror is moved into the determined desired orientation based upon the control signal. For example, actuators 16, 18 and 20 may move the mirror into the determined desired orientation based on the control signals from DMS 12.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An automatic mirror adjustment arrangement for a motor vehicle, comprising:
a sensor configured to detect a height of eyes of a driver of the motor vehicle;
an electronic processor communicatively coupled to the sensor and configured to:
determine a desired orientation of a mirror within the motor vehicle based upon the detected height of the eyes of the driver; and
transmit a control signal dependent upon the determined desired orientation of the mirror; and
an actuator communicatively coupled to the electronic processor and configured to:
receive the control signal; and
move the mirror into the determined desired orientation based upon the control signal.

2. The arrangement of claim 1 wherein the sensor is configured to detect the height of the eyes of the driver relative to a vertical position of the sensor.

3. The arrangement of claim 1 wherein the sensor comprises a camera.

4. The arrangement of claim 1 wherein the electronic processor is configured to determine the desired orientation of the mirror within the motor vehicle by looking up the desired orientation of the mirror in a lookup table in a memory device wherein the desired orientation of the mirror is stored in association with the detected height of the eyes of the driver.

5. The arrangement of claim 1 wherein the mirror comprises a side view mirror or a rearview mirror.

6. The arrangement of claim 1 wherein the movement of the mirror to the desired orientation improves a view of the driver of a space outside of the motor vehicle.

7. The arrangement of claim 1 further comprising a dashboard of the motor vehicle, the dashboard supporting the sensor.

8. An automatic mirror adjustment method for a motor vehicle, the method comprising:
detecting a height of eyes of a driver of the motor vehicle;
determining a desired orientation of a mirror within the motor vehicle based upon the detected height of the eyes of the driver;
transmitting a control signal dependent upon the determined desired orientation of the mirror; and
moving the mirror into the determined desired orientation based upon the control signal.

9. The method of claim 8 wherein the detecting includes detecting the height of the eyes of the driver relative to a vertical position of a sensor that performs the detecting.

10. The method of claim 8 wherein the detecting is performed by a camera.

11. The method of claim 8 wherein the determining of the desired orientation of the mirror within the motor vehicle is performed by looking up the desired orientation of the mirror in a lookup table in a memory device wherein the desired orientation of the mirror is stored in association with the detected height of the eyes of the driver.

12. The method of claim 8 wherein the mirror comprises a side view mirror or a rearview mirror.

13. The method of claim 8 wherein the moving of the mirror to the desired orientation improves a view of the driver of a space outside of the motor vehicle.

14. The method of claim 8 further comprising:
providing a dashboard within the motor vehicle; and
supporting the sensor by use of the dashboard.

15. An automatic mirror adjustment arrangement for a motor vehicle, comprising:
a sensor configured to detect a three-dimensional location of eyes of a driver of the motor vehicle;
an electronic processor communicatively coupled to the sensor and configured to:
determine a desired orientation of a mirror within the motor vehicle based upon the detected three-dimensional location of the eyes of the driver; and
transmit a control signal dependent upon the determined desired. orientation of the mirror; and
an actuator communicatively coupled to the electronic processor and configured to:
receive the control signal; and
move the mirror into the determined desired orientation based upon the control signal.

16. The arrangement of claim 15 wherein the sensor comprises a camera.

17. The arrangement of claim 15 wherein the electronic processor is configured to determine the desired orientation of the mirror within the motor vehicle by looking up the desired orientation of the mirror in a lookup table in a memory device wherein the desired orientation of the mirror is stored in association with the detected three-dimensional location of the eyes of the driver.

18. The arrangement of claim 15 wherein the mirror comprises a side view mirror or a rearview mirror.

19. The arrangement of claim 15 wherein the movement of the mirror to the desired orientation improves a view of the driver of a space outside of the motor vehicle.

20. The arrangement of claim 15 further comprising a dashboard of the motor vehicle, the dashboard supporting the sensor.
